(19) United States
(12) Patent Application Publication
(10) Pub. No.: US 2008/0012693 A1
(43) Pub. Date: Jan. 17, 2008

(54) Vehicle communication system

(75) Inventor: Toshio Shimomura, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/822,788

(22) Filed: Jul. 10, 2007

(30) Foreign Application Priority Data
Jul. 11, 2006 (JP) 2006-190874
May 31, 2007 (JP) 2006-144516

(51) Int. Cl. B60R 25/10

(52) U.S. Cl. 340/426.1; 340/425.5

(57) ABSTRACT

A vehicle communication system includes a plurality of vehicles each having a theft detection device, and an external station that communicates with telephone devices of the vehicle. Each vehicle includes an inter-vehicle communication device, a memory storing an ID code, a control unit that executes communication control of the telephone device and an inter-vehicle communication device. The control unit transmits vehicle information of the subject vehicle or the vehicle information of another vehicle when the telephone device can communicate, and transmits the vehicle information on the subject vehicle or the vehicle information on another vehicle by the inter-vehicle communication device when the telephone device cannot communicate.

### CROSS REFERENCE TO RELATED APPLICATION

The present invention is related to and incorporates herein by reference Japanese Patent Applications No. 2006-190874 filed on Jul. 11, 2006 and No. 2007-144516 filed on May 31, 2007.

### FIELD OF THE INVENTION

The present invention relates to a vehicle communication system that conducts communications between a vehicle and an external station.

### BACKGROUND OF THE INVENTION

In a conventional vehicle communication system disclosed in JP-A-2003-146185, when a vehicle is stolen and an external station receives a message on the vehicle theft through a phone, the external station transmits to the stolen vehicle a remote signal that prohibits startup of an engine of the stolen vehicle. Then, when a communication device that is incorporated into the stolen vehicle receives the remote signal, the engine cannot start up. However, it is impossible to receive the remote signal transmitted from the external station when the communication device of the stolen vehicle fails.

Also, the communication between the vehicle and the external station is frequently conducted by using a telephone network. Accordingly, in this vehicle communication system, the remote signal transmitted from the external station cannot be received either, when the vehicle is out of a communication zone of the telephone.

### SUMMARY OF THE INVENTION

The present invention has an object to provide a vehicle communication system, which surely conducts a communication with an external station so as to receive a remote signal that is transmitted from the external station.

According to one aspect of the present invention, a vehicle communication system comprises a first communication device, a second communication device and a control unit, which are mounted on a subject vehicle. The first communication device communicates with an external station having a communication device through a communication infrastructure. The second communication device communicates with a plurality of vehicles other than the subject vehicle. The control unit executes a communication control of the first communication device and the second communication device. Specifically, the control unit confirms whether communication can be conducted by the first communication device, receives a remote operation signal including an ID code transmitted from the external station by the first communication device when the first communication device is capable of communication, and receives the remote operation signal by the second communication device when the first communication device is incapable of communication.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an antitheft system using a communication system according to an embodiment of the present invention;

FIG. 2 is a flowchart showing a processing operation of a control unit according to the embodiment of the present invention;

FIG. 3 is a flowchart showing a processing operation of a control unit of a vehicle that receives vehicle information according to the embodiment of the present invention;

FIG. 4 is a flowchart showing a transmission processing operation of a remote signal of an external station according to the embodiment of the present invention;

FIG. 5 is a flowchart showing a transmitting and receiving operation of the remote signal of the control unit according to the embodiment of the present invention; and

FIG. 6 is a flowchart showing a processing operation of the vehicle control unit that receives the remote signal according to the embodiment of the present invention.

### DETAILED DESCRIPTION OF THE PREFERRED EMBODIMENTS

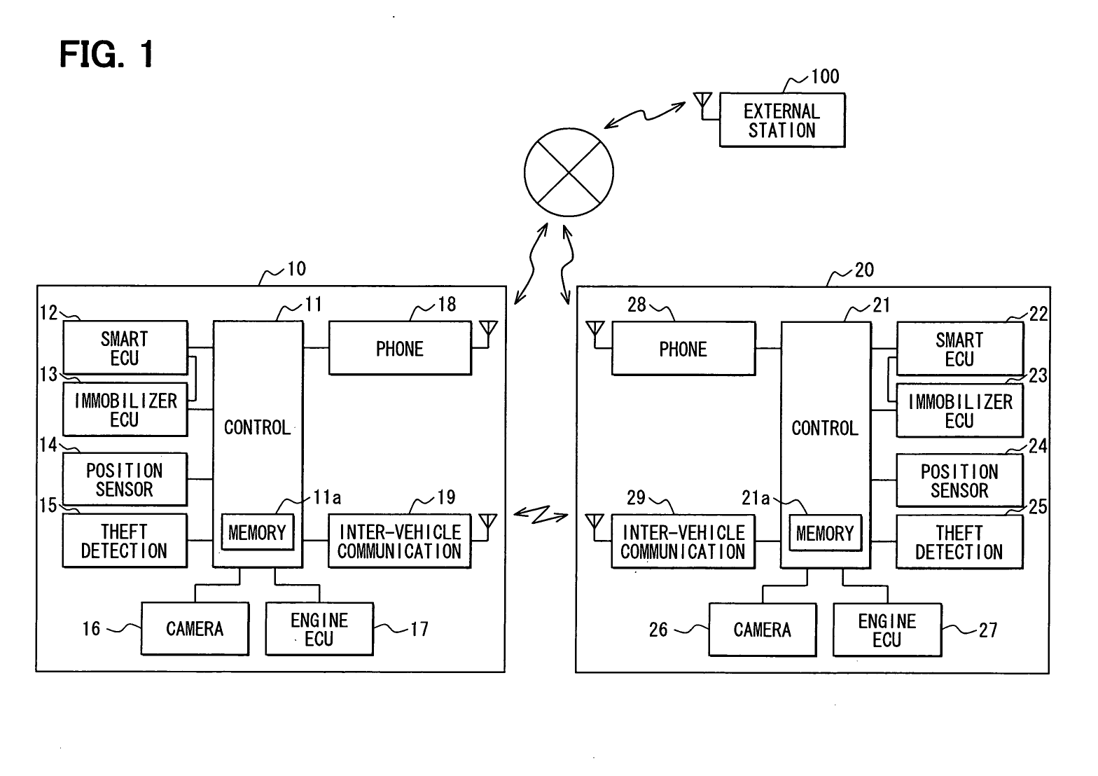

A vehicle communication system is shown as a vehicle antitheft system in FIG. 1. This antitheft system is made up of vehicles 10, 20 and an external station (center) 100. Each vehicle 10, 20 has a theft detection device 15. The external station 100 communicates with the vehicles, specifically telephone devices 18, 28. A user conducts the user's registration for the use of this system in the external station 100 in advance. An ID code for specifying the vehicle of the user is given to the vehicle of the user at the time of registering the user. Information including the ID code is transmitted from the vehicle of the user. Upon receiving the signal that is transmitted from the vehicle of the user, the external station 100 checks the ID code included in the received signal with the ID code that has been registered in advance to specify the vehicle that transmits the signal.

The vehicles 10 and 20 have the same communication systems. Also, a plurality of vehicles using this system other than the vehicles 10 and 20 also has the same communication devices. The vehicles 10, 20 include control units 11, 21, memories (ID code storage device) 11a, 21a, smart ECUs 12, 22, immobilizer ECUs 12, 23, vehicle position sensors 14, 24, theft detection devices (abnormality detection devices) 15, 25, cameras 16, 26, engine ECUs 17, 27, telephone devices (first communication devices) 18, 28, and inter-vehicle communication devices (second communication devices) 19, 29. Because the vehicles 10 and 20 have the same communication systems with each other, the following description is made with reference to the vehicle 10.

The control unit (communication control means) 11 includes mainly a microcomputer including a memory 11a, a clock, a CPU, a ROM and a RAM. The CPU operates according to a program that has been stored in the ROM. Also, the CPU reads and writes information with respect to the RAM to meet the needs of the operation of the CPU. Also, the CPU delivers various signals with respect to the smart ECU 12, the immobilizer ECU 13, the vehicle position sensor 14, the theft detection device 15, the camera 16, the engine ECU 17, the telephone device 18, and the inter-vehicle communication device 19. The memory 11a may be an EEPROM, in which the ID code for specifying the vehicle is stored.

The control unit 11 transmits a present position signal indicative of the present position coordinates (present position) of the subject vehicle 10, which is detected by the vehicle position sensor 14 and the ID code by means of the telephone device 18 in each of given periods. Also, the control unit 11 transmits a signal indicative of vehicle information (e.g., at least one of ID code, the present position, image information and the present time) together with a signal indicating that the subject vehicle 10 has been stolen by means of the telephone device 18 or the inter-vehicle communication device 19, on the basis of a theft signal from the theft detection device 15.

The smart ECU 12 is a control unit of a smart entry and smart ignition system, and includes mainly a microcomputer. The smart ECU 12 also includes a memory such as a ROM, a RAM, or an EEPROM and an interface circuit or a data transfer bus line. The smart ECU 12 conducts a radio communication with respect to a mobile device that can be carried by the user, and automatically checks an authentication code that has been transmitted from the mobile device with an authentication code that has been stored in the memory of the smart ECU 12. Then, the smart ECU 12 locks or unlocks vehicle doors when fulfilling the requirements that the respective authentication codes satisfy a given relationship (checking result is OK). On the other hand, when the authentication code that has been transmitted from the mobile device and the authentication code that has been stored in the memory of the smart ECU 12 do not satisfy the given relationship (checking result is NG), the smart ECU 12 does not conduct the lock/unlock of the vehicle doors so that the vehicle may not be used. Also, the smart ECU 12 outputs the lock/unlock signal indicative of the lock or unlock of the vehicle doors to the control unit 11.

The immobilizer ECU 13 includes mainly a microcomputer including a memory such as a ROM, a RAM or an EEPROM, and an interface circuit or a data transfer bus line. The immobilizer ECU 13 outputs a drive signal indicative of a drive prohibition or drive permission of an engine (not shown) to the engine ECU 17 on the basis of the results of checking the authentication codes by the smart ECU 12 and a remote signal (control signal, remote set signal, remote unset signal) that is transmitted from the external station 100. Upon receiving the remote signal addressed to the subject vehicle, the control unit 11 produces the vehicle information and transmits the vehicle information to the external station 100.

The engine ECU 17 includes mainly a microcomputer including a memory such as a ROM, a RAM or an EEPROM, and an interface circuit or a data transfer bus line. The immobilizer ECU 13 unsets the immobilizer function, only when the drive signal indicative of the drive permission of the engine has been output, that is, when the results of the authentication codes due to the smart ECU 12 are allowed, and when the remote unset signal has been received. In this instance, the engine ECU 17 starts the operation of a starter motor, a fuel injection device, and an ignition device on the basis of an ignition switch signal from an ignition switch (not shown). As a result, fuel is injected into the engine while the starter motor is rotating, and the ignition plug is ignited, to thereby start the engine (drive allowed).

Also, the immobilizer ECU 13 sets the immobilizer function, only when the drive signal indicative of the drive prohibition of the engine has been output, that is, when the results of the authentication codes due to the smart ECU 12 are not allowed, and when the remote set signal has been received. In this instance, the engine ECU 17 does not start the operation of at least one of the starter motor, the fuel injection device, and the ignition device. That is, the engine ECU 17 does not start the engine (drive prohibited).

The vehicle position sensor 14 includes various sensors such as a GPS (global positioning system) receiver, a gyro scope, a distance sensor and a geomagnetic sensor, as a device for detecting the present position of the subject vehicle. The detected present position is input to the control unit 11. Since those sensors have detection errors different in property from each other, those sensors conduct position detection with high precision while complementing the detection errors each other. Also, it is unnecessary to provide all of the sensors depending on a level of the required detection precision, and the required sensors can be appropriately selected.

The theft detection device 15 detects the theft action of the vehicle 10, and includes a break-in (intrusion) sensor, a vibration sensor; an inclination sensor and a glass break sensor. The break-in sensor has a ultrasonic sensor or an electric wave sensor which is directed toward the interior of the vehicle, and detects a person who breaks in the interior of the vehicle by the ultrasonic sensor or the electric wave sensor. The vibration sensor has an acceleration sensor and detects the vibration of the vehicle by the acceleration sensor. The inclination sensor is formed of an inclination angle sensor, and detects that the posture of the vehicle rapidly changes, that is, is rapidly inclined by the inclination angle sensor. The glass break sensor has a device which detects that conductors which are embedded in the glass of the vehicle are disconnected due to shatter of the glass, and detects that the glass is broken. The theft detection device 15 (the break-in sensor, the vibration sensor, the inclination sensor, the glass break sensor) starts the detection operation on the basis of a control signal from the control unit 11. When the theft detection device 15 detects the theft action on the vehicle 10, the theft detection device 15 notifies the control unit 11 of a theft signal indicating that the theft is detected. Also, it is unnecessary to provide all of the sensors depending on a level of the required detection precision, and the required sensors can be appropriately selected.

The camera 16 includes a front camera, side cameras and a rear camera, which take images around the vehicle, that is, in front of the vehicle, at sides of the vehicle and in the rear of the vehicle, as well as an omni-direction camera that takes images in the interior of the vehicle in all directions, and images around the vehicle which are viewable from the windows. The camera 16 operates to image surrounding views on the basis of the control signal from the control unit 11, and outputs an image signal indicative of the taken image information to the control unit 11.

The ambient environment of the vehicle 10 may be that the periphery of the vehicle 10 is dark by night or underneath the elevated railway tracks. Accordingly, when the control unit 11 outputs a control signal indicative of the start of imaging to the camera 16, the control unit 11 is capable of outputting a control signal indicative of lighting to a lamp in the interior of the vehicle so as to turn on the lamp in the interior of the vehicle. Also, an imaging lamp (strobe) can be provided. In this case, the control unit 11 is capable of outputting the control signal indicative of lighting to the imaging lamp to turn on the imaging lamp when the control unit 11 outputs the control signal indicative of the start of imaging to the camera 16.

The telephone device 18 may be an in-vehicle data communication module (DCM) that conducts radio communications (data communications, voice communications) through a telephone network (communication infrastructure) including a base station, or a cellular phone. The inter-vehicle communication device 19 may be a Bluetooth modem that is a short distance radio system that conducts communications (data communications) in a free radio frequency band which is capable of conducting direct communications between the vehicles not through the telephone network, that is, which can be used in a limited zone, or an infrared communication device.

The external station 100 includes mainly a microcomputer, and includes a memory such as a ROM, a RAM or an EEPROM, an interface circuit or a data transfer bus line, a center side telephone device (external station 100 side communication device) that conducts communications with the telephone device 18 or the cellular phone through the telephone network, and a storage device that may be a hard disk. The hard disk stores a database that manages the vehicle information (the ID code, the present position, etc.) which is transmitted from a large number of vehicles. Upon receiving the signal indicating that the subject vehicle 10 has been stolen as well as a signal indicative of the vehicle information (the ID code, the present position, the image information, the present time, etc.) of the subject vehicle 10 from the vehicle 10, the external station 100 notifies a police station, a security company, or a place that has been registered in advance such as the user of the subject vehicle of a fact that the theft action of the vehicle has occurred.

In the antitheft system, when the vehicle has been stolen, the user of the vehicle conducts communications with the external station 100 by the cellular phone to report the theft. The external station 100 that receives the theft report transmits a remote set signal to the vehicle.

Also, when the stolen vehicle has been found out, the user of the vehicle reports the finding of the stolen vehicle to the external station 100 by the cellular phone. The external station 100 that receives the report of finding the stolen vehicle transmits a remote unset signal to the vehicle.

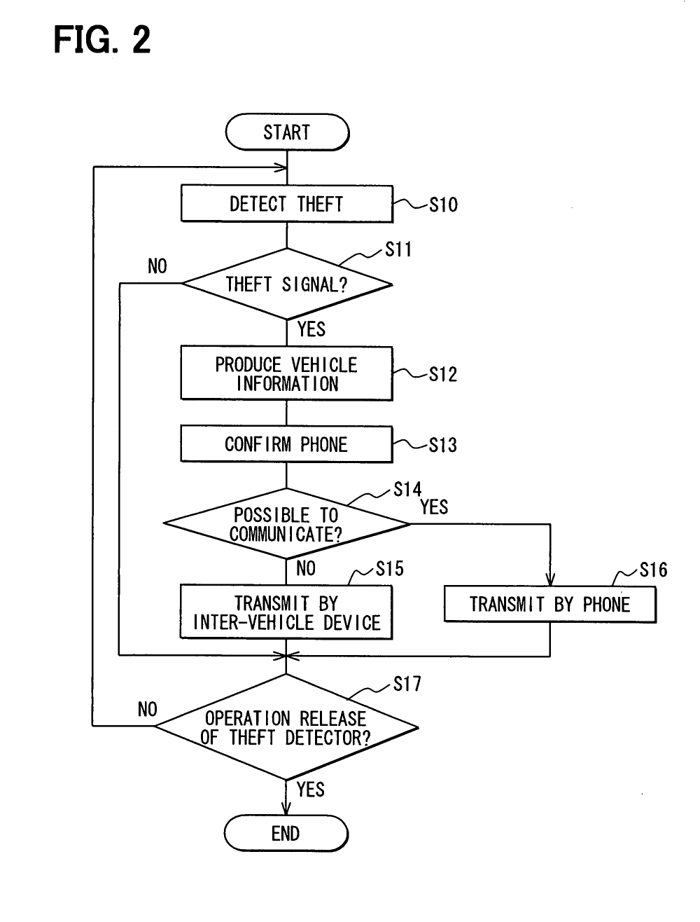

The operation of the antitheft system according to this embodiment is described next with reference to FIG. 2.

The control unit 11 starts the processing operation shown in FIG. 2, after the vehicle is put at rest. In this instance, the control unit 11 stops the detection conducted by the theft detection device 15 and imaging conducted by the camera 16 when the ignition switch of the vehicle 10 is turned on. Further, the control unit 11 turns off the ignition switch from the ON state, and the smart ECU 12 locks all of the doors of the vehicle 10 and outputs a lock signal indicative of the lock. Alternatively, the control unit 11 may start the processing operation shown in FIG. 2 after a given period of time (a period of time of the degree required to open the door, get off the vehicle, and close the door) has elapsed since the engine turns off.

First, at step S10, the control unit 11 outputs a control signal indicative of a detection start to the theft detection device 15, which may include the break-in sensor, the vibration sensor, the inclination sensor, or the glass break sensor. Upon receiving the control signal, the theft detection device 15 operates the break-in sensor, the vibration sensor, the inclination sensor, and the glass break sensor, and starts to detect the theft action of the vehicle 10.

At step S11, the control unit 11 checks whether there is a theft signal from the theft detection device 15 or not. When the control unit 11 determines that there is the theft signal, the processing is advanced to step S12. On the other hand, when the control unit 11 determines that there is no theft signal, the processing is advanced to step S17.

At step S12, the control unit 11 produces the vehicle information. In this example, the control unit 11 outputs the control signal indicative of the start of imaging to the camera 16 in order to have the image of the theft scene included in the vehicle information. Then, the control unit 11 produces the vehicle information including the ID code for specifying the vehicle which is stored in the memory 11a, the present position signal indicative of the present position of the subject vehicle 10 which is detected by the vehicle position sensor 14, and the present time signal that is timed by the clock in addition to the image signal indicative of the image information taken by the camera 16.

At step S13, the control unit 11 confirms whether a communication can be conducted by the telephone device 18 or not. When the vehicle 10 has been stolen, there is the possibility that the communications cannot be conducted because the telephone device 18 is destroyed, or the communication cannot be conducted because the vehicle 10 is out of the communication zone of the telephone network. Accordingly, the processing of step S13 checks whether the theft of the vehicle 10 can be notified the external station 100 of or not.

At step S14, the control unit 11 checks whether the communication can be conducted by the telephone device 18 or not, on the basis of the processing at step S13. In the case the control unit 11 determines that the communication is possible by the telephone device 18, the processing is advanced to step S16. On the other hand, when the control unit 11 determines that the communication cannot be conducted by the telephone device 18, the processing is advanced to step S15.

At step S16, the control unit 11 transmits the vehicle information that has been produced at step S12 to the external station 100 by the telephone device 18.

On the other hand, when the communication cannot be conducted by the telephone device 18, the control unit 11 transmits the vehicle information that has been produced at step S12 by the inter-vehicle communication device 19 at step S15. The inter-vehicle communication device 19 conducts the communication only within the limited zone. Accordingly, when the control unit 11 transmits the vehicle information by means of the inter-vehicle communication device 19, the control unit 11 transmits the vehicle information to a vehicle (for example, the vehicle 20) that exists in the periphery of the subject vehicle 10 (the vehicle 10 that has transmitted the vehicle information). Then, the vehicle 20 that has received the vehicle information transmits the vehicle information that has been automatically received by the telephone device 18 to the external station 100. The processing operation of the vehicle 20 will be described in more detail later. Also, the external station 100 that has received the vehicle information notifies a police station, a security company, or a place that has been registered in advance such as the user of the subject vehicle 10 (the vehicle that has transmitted the vehicle information) of a fact that the theft action of the vehicle has occurred.

At step S17, the control unit 11 checks whether the operation of the theft detection device 15 is released or not, according to whether the smart ECU 12 unlocks the partial door of the vehicle 10 with OK of the checking or not. Then, when the control unit 11 determines that the operation of the theft detection device 15 is released, the control unit 11 terminates the processing. On the other hand, when the control unit 11 does not determine that the operation of the theft detection device 15 is released, the control unit 11 returns to step S10.

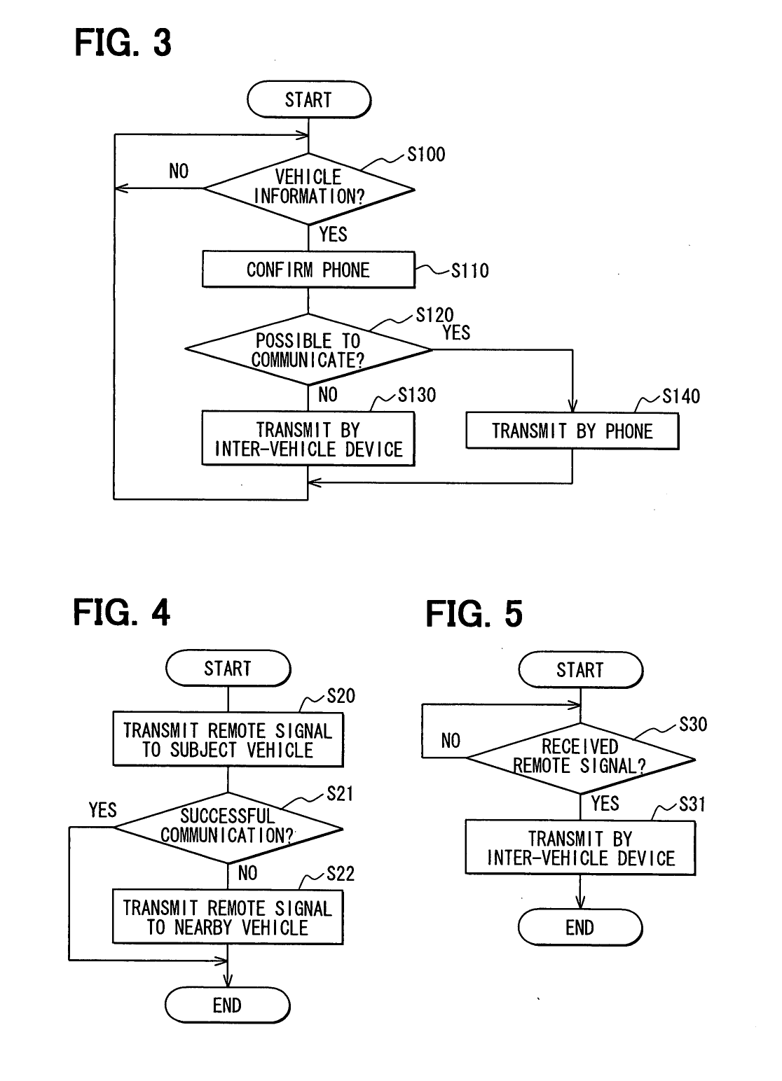

Subsequently, the processing operation of the vehicle (the vehicle 20 in this example) that has received the vehicle information which has been transmitted at step S15 of FIG. 2 is described. FIG. 3 is a flowchart showing the processing operation of the vehicle control unit 11 that has received the vehicle information according to the first embodiment of the present invention. The control unit 21 executes the processing shown in FIG. 3 while a power is supplied to the control unit 21.

At step S100, the control unit 21 checks whether the inter-vehicle communication device 29 has received the vehicle information or not. When the control unit 21 determines that the inter-vehicle communication device 29 has received the vehicle information, the processing is advanced to step S110. On the other hand, when the control unit 21 determines that the inter-vehicle communication device 29 has not received the vehicle information, the control unit 21 repeats the check operation at step S100.

At step S110, the control unit 21 checks whether the communication can be conducted by the telephone device 28 or not. There is the possibility that the vehicle 20 cannot conduct the communication because the telephone device 28 fails, or cannot conduct the communication because the vehicle 20 is out of the communication zone of the telephone network. Accordingly, the processing at step S110 is conducted to confirm whether the vehicle 20, to which the vehicle information has been transmitted from the vehicle 10, that is, to which the notification from the vehicle 10 to the external station 100 has been consigned, can be reported to the external station 100 of the vehicle information or not.

At step S120, the control unit 21 checks whether the communication can be conducted by the telephone device 28 or not, on the basis of the processing at step S110. When the control unit 21 determines that the communication can be conducted by the telephone device 28, the processing is advanced to step S140. On the other hand, when the control unit 21 determines that the communication cannot be conducted by the telephone device 28, the processing is advanced to step S130.

At step S140, the control unit 21 transmits the vehicle information that has been received by the inter-vehicle communication device 29 to the external station 100 by the telephone device 28.

On the other hand, when the communication cannot be conducted by the telephone device 28, the control unit 21 transmits the vehicle information that has been received by the inter-vehicle communication device 29 by the inter-vehicle communication device 29 at step S130. The inter-vehicle communication device 29 conducts the communication only in the limited zone. Therefore, when the vehicle information is transmitted by the inter-vehicle communication device 29, the control unit 21 transmits the vehicle information to the vehicle that exists in the periphery of the subject vehicle 20. That is, the vehicle information that has been transmitted by the vehicle 10 is transmitted by the inter-vehicle communication devices of the plural vehicles using the same or similar system. In this way, even if the vehicle 10 cannot communicate with the external station 100, the communication with the external station 100 can be consigned to another vehicle using this system by the inter-vehicle communication device.

The operation of transmitting or receiving the remote signal by the external station 100 and the vehicle is made as shown in FIGS. 4 to 6. It is assumed that the vehicle 10 is a subject vehicle that has been stolen, and the vehicle 20 is a nearby vehicle present near the subject vehicle (vehicle 10).

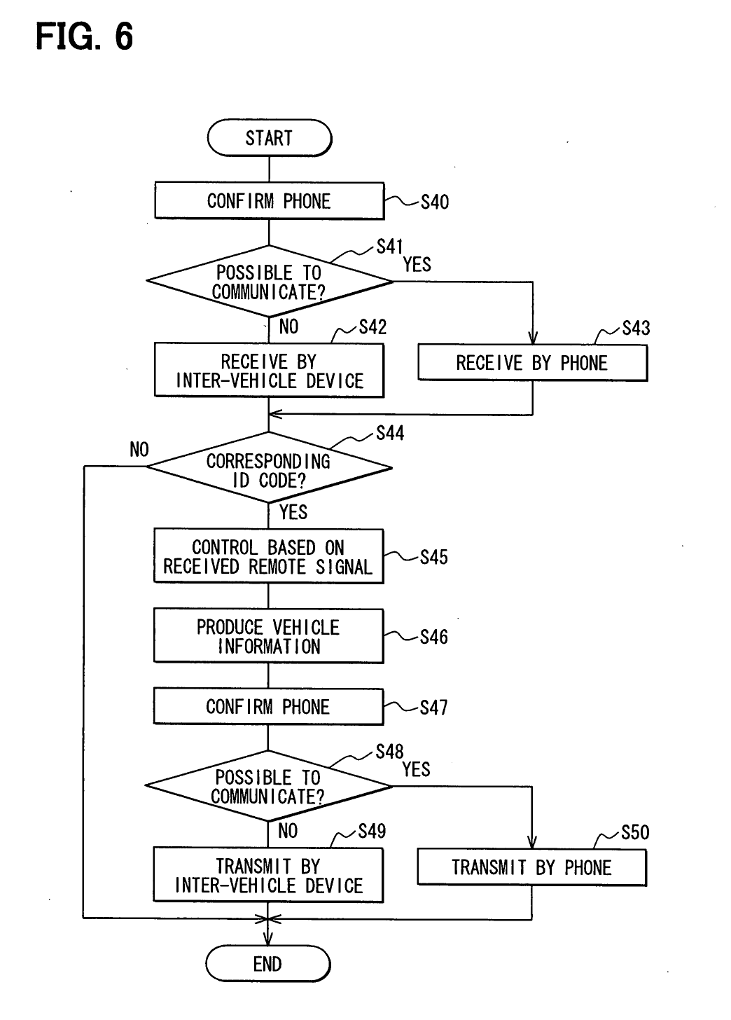

Upon receiving the notification of the theft from the user or the notification of finding of the stolen vehicle, the external station 100 starts the processing shown in FIG. 4. Also, the control unit 21 executes the processing shown in FIG. 5 while a power is supplied to the control unit 21. In addition, the control unit 11 executes the processing shown in FIG. 6 while a power is supplied to the control unit 11.

At step S20, the external station 100 transmits the remote signal (either a remote set signal or a remote unset signal, and the ID code of the subject vehicle) to the subject vehicle on the basis of the notification of the theft from the vehicle user, or the notification of finding of the stolen vehicle. That is, when the external station 100 receives the notification of the theft from the user of the vehicle, the external station 100 transmits the remote set signal and the ID code of the subject vehicle to the subject vehicle. Also, when the external station 100 receives the notification of finding of the stolen vehicle from the user of the vehicle, the external station 100 transmits the remote unset signal and the ID code of the subject vehicle to the subject vehicle.

Then, at step S21, the external station 100 checks whether the communication with the vehicle 10 has been successful or not, that is, the vehicle 10 has received the remote signal or not. When the external station 100 determines that the communication has been successful, the external station 100 terminates the processing. When the external station 100 determines that the communication has been unsuccessful, the processing is advanced to step S22. As described above, when the vehicle 10 has been stolen, there is the possibility that the communication cannot be conducted because the telephone device 18 is destroyed, or the communication cannot be conducted because the vehicle 10 is out of the communication zone of the telephone network. Accordingly, the processing at step S21 is conducted to confirm whether the remote signal can be transmitted to the vehicle 10 or not. Although the details will be described later with reference to FIG. 6, upon receiving the remote signal addressed to the subject vehicle, the vehicle 10 transmits the vehicle information to the external station 100. The external station 100 checks whether the vehicle information has been transmitted from the vehicle to be transmitted after the transmission of the remote signal or not, thereby determining whether the communication has been successful or not.

At step S22, the external station 100 transmits the remote signal and the ID code to the nearby vehicle (vehicle 20) that is close to the latest present position which is transmitted by the vehicle 10 by the database. Alternatively, the external station 100 estimates the travel course of the subject vehicle 10 on the basis of the record of the present position information which has been transmitted by the subject vehicle 10 in the past, and transmits the remote signal and the ID code to the nearby vehicle (vehicle 20) that exists in the vicinity of the estimated travel course. As described above, the external station 100 transmits the remote signal and the ID code, thereby making it possible to transmit the remote signal to only a vehicle that exists in the vicinity of the subject vehicle 10 with high possibility.

On the other hand, the control unit 21 of the vehicle 20 checks whether the external station 100 has received the remote signal that has been transmitted by the external station 100 or not, at step S30. When the control unit 21 determines that the external station 100 has received the remote signal, the processing is advanced to step S31. On the other hand, when the control unit 21 determines that the external station 100 has not received the remote signal, the control unit 21 repeats the check processing at step S30.

At step S31, the control unit 21 of the vehicle 20 transmits the received remote signal to the vehicle 10 by the inter-vehicle communication device 29. Here, the received remote signal is assumed to be a signal for the other vehicle. The remote signal is, however, for the subject vehicle in some cases and for the other vehicle in other cases. Therefore, the control unit 21 checks whether the ID code included in the received remote signal corresponds to the ID code stored in the memory 21a. The remote signal is determined to be for itself (vehicle 20) when the ID codes correspond to each other. The remote signal is determined to be for the other vehicle when the ID codes do not correspond to each other.

When the control unit 21 transmits the remote signal by the inter-vehicle communication device 29, the control unit 21 transmits the remote signal to the vehicle 10 that exists near the vehicle 20. That is, the remote signal that has been transmitted by the external station 100 is transmitted by the inter-vehicle communication devices 21 of the plurality of vehicles 20 using this system until the vehicle 10 that exists near the vehicle 20 receives the remote signal. In this way, the vehicle 10 is capable of consigning the communication with the external station 100 to other vehicles using this system by the inter-vehicle communication devices even if the vehicle 10 is incapable of communicating with the external station 100.

At step S40, the control unit 11 in the vehicle 10 confirms whether it is possible to communicate by the telephone device 18 or not, as at step S13 of FIG. 2. At step S41, the control unit 11 checks whether the communication can be conducted by the telephone device 18 or not, on the basis of the processing at step S13, as at step S14 of FIG. 2. When the control unit 11 determines that the communication can be conducted by the telephone device 18, the processing is advanced to step S43. On the other hand, when the control unit 11 determines that the communication cannot be conducted by the telephone device 18, the processing is advanced to step S42.

At step S43, the control unit 11 receives the remote signal that is transmitted from the external station 100 by the telephone device 18. On the other hand, when the communication cannot be conducted by the telephone device 18, the control unit 11 receives the remote signal that is transmitted from the vehicle 20 by the inter-vehicle communication device 19.

At step S44, the control unit 11 checks whether the ID code that is included in the remote signal corresponds to the ID code that has been stored in the memory 11a or not. When it is the corresponding ID code, the processing is advanced to step S45. On the other hand, when it is not the corresponding ID code, the control unit 11 terminates the processing.

At step S45, the control unit 11 conducts the control according to the received remote signal. For example, when the remote signal is the remote set signal, the control unit 11 does not start the operation of at least one of the starter motor, the fuel injection device, and the ignition device. At step S46, the control unit 11 produces the vehicle information as at step S12 of FIG. 2.

At steps S47 to S50, the control unit 11 executes the control as at steps S13 to S16 of FIG. 2, and transmits the vehicle information. The control unit 11 terminates the processing after transmitting the vehicle information.

It is to be noted that, since the vehicle 10 is assumed to have been stolen, the processing operation is described as being terminated after step S44, if the ID code is not a corresponding one. However, the vehicle 10 transmits in actuality the remote signal by the inter-vehicle communication device 19 as shown in FIG. 5 if the ID code is not the corresponding one. Although not described in detail for brevity, the control unit 21 performs in actuality steps S45 to S50 shown in FIG. 6 in its processing of FIG. 5, if the ID code in the received remote signal corresponds to the ID code stored in the memory 21a, that is, if the received remote signal is for the vehicle 20.

As described above, the antitheft system uses the inter-vehicle communication device 19 and the nearby vehicle 20 as alternate means of the telephone device 18, when the communication cannot be conducted by the telephone device 18.

The telephone device and the inter-vehicle communication device are switched over to conduct the communication, and the communication between the external station and the vehicle is surely conducted by the nearby vehicle even if the communication cannot be conducted because the telephone device of the vehicle is destroyed, or the communication cannot be conducted because the vehicle is out of the communication zone of the telephone network, thereby making it possible that the stolen vehicle 10 receives the remote signal that is transmitted from the external station 100.

Also, upon receiving the remote signal addressed to the subject vehicle, the control unit 11 produces the vehicle information including the image signal, the ID code for specifying the vehicle, the present position signal, and the present time signal. Then, the telephone device and the inter-vehicle communication device are switched over to conduct the communication, and the communication between the external station and the vehicle is surely conducted by the nearby vehicle even if the communication cannot be conducted because the telephone device of the vehicle is destroyed, or the communication cannot be conducted because the vehicle is out of the communication zone of the telephone network, thereby making it possible that the vehicle 10 transmit the vehicle information to the external station 100.

The external station 100 is capable of conducting the following operation by receiving the vehicle information that is transmitted from the vehicle 10 after the transmission of the remote signal to the vehicle 10. That is, the external station 100 is capable of confirming that the vehicle 10 has received the remote signal on the basis of the ID code for identifying the vehicle. Also, the external station 100 is capable of grasping passengers within the vehicle 10 or the statuses of the exterior and interior of the vehicle on the basis of the image signal. The external station 100 is capable of using the above information, thereby making it possible to easily find out the stolen vehicle or a stealing person.

The above embodiment may be modified in many ways without departing from the spirit and scope of the present invention.

What is claimed is:

1. A vehicle communication system, comprising:
a first communication device that communicates with an external station having a communication device through a communication infrastructure;
a second communication device that communicates with a plurality of vehicles;
an ID code storing means for storing an ID code that specifies a subject vehicle; and
communication control means for executing a communication control of the first communication device and the second communication device,
wherein the communication control means confirms whether communication can be conducted by the first communication device, receives a remote operation signal including an ID code transmitted from the external station by the first communication device when the first communication device is capable of communication, and receives the remote operation signal by the second communication device when the first communication device is incapable of communication.

2. The vehicle communication system according to claim 1, further comprising:
instruction means for instructing transmission of vehicle information of the subject vehicle,
wherein the communication control means confirms whether the first communication device is capable of communication when an instruction from the instruction means is provided, transmits the vehicle information of the subject vehicle by the first communication device when the first communication device is capable of communication, and transmits the vehicle information of the subject vehicle by the second communication device when the first communication device is incapable of communication.

3. The vehicle communication system according to claim 1,
wherein the communication control means confirms whether the first communication device is capable of communication when the communication control means receives the vehicle information on another vehicle by the second communication device, transmits the vehicle information of the other vehicle by the first communication device when the first communication device is capable of communication, and transmits the vehicle information of the other vehicle by the second communication device when the first communication device is incapable of communication.

4. The vehicle communication system according to claim 1,
wherein the communication control means confirms whether the first communication device is capable of the communication when the communication control means receives the remote operation signal, transmits the vehicle information of the subject vehicle by the first communication device when the first communication device is capable of communication, and transmits the vehicle information of the subject vehicle by the second communication device when the first communication device is incapable of communication.

5. The vehicle communication system according to claim 2, further comprising:
an abnormality detection device that detects an abnormality of the subject vehicle,
wherein the instruction means instructs transmission of the vehicle information of the subject vehicle when the abnormality of the subject vehicle is detected by the abnormality detection device, and the communication control means adds the detection contents of the abnormality detection device to the vehicle information of the subject vehicle and transmits the vehicle information.

6. The vehicle communication system according to claim 5,
wherein the abnormality detection device includes a theft detection device that detects theft of the subject vehicle.

7. The vehicle communication system according to claim 1,
wherein the remote operation signal includes a signal that controls drive prohibition or drive permission of a motive power source in the vehicle.

8. The vehicle communication system according to claim 1,
wherein each of the plurality of vehicles includes at least one of a vehicle position sensor that detects a present position of a subject vehicle, a camera that images at least periphery of the subject vehicle, and a clock that times the present time, and
wherein the communication control means transmits the vehicle information including at least one of the present position that has been detected by the vehicle position sensor, image information that has been taken by the camera, and the present time that has been timed by the clock in addition to the ID code.

9. The vehicle communication system according to claim 8,
wherein the vehicle information includes present position information of the subject vehicle, and the ID code, and
wherein the communication control means transmits the vehicle information by the first communication device in each of given time points.

10. The vehicle communication system according to claim 4,
wherein the external station transmits the remote operation signal to another vehicle different from the subject vehicle when the external station is incapable of receiving the vehicle information that is transmitted from the subject vehicle after transmitting the remote operation signal to the subject vehicle.

11. The vehicle communication system according to claim 10,
wherein the external station transmits the remote operation signal when a notification from the user of the vehicle is provided.

12. The vehicle communication system according to claim 9,
wherein the external station specifies the other vehicle to which the remote operation signal is to be transmitted on the basis of the record of the present position information which has been transmitted by the subject vehicle in the past, and transmits the remote operation signal to another vehicle different from the subject vehicle when the external station is incapable of receiving the vehicle information that is transmitted from the subject vehicle after transmitting the remote operation signal to the subject vehicle.
